(19) United States
(12) Patent Application Publication
(10) Pub. No.: US 2017/0230129 A1
(43) Pub. Date: Aug. 10, 2017

(54) APPARATUS, PORTABLE APPARATUS AND METHOD FOR DETECTING PASSIVE INTERMODULATION

(71) Applicant: ELECTRONICS AND TELECOMMUNICATIONS RESEARCH INSTITUTE, Daejeon (KR)

(72) Inventors: Sung Jin YOO, Daejeon (KR); Kyu Min KANG, Daejeon (KR); Seung Keun PARK, Daejeon (KR); Jae Cheol PARK, Daejeon (KR); Jung Sun UM, Daejeon (KR); Hoi Yoon JUNG, Daejeon (KR)

(21) Appl. No.: 15/217,884

(22) Filed: Jul. 22, 2016

(30) Foreign Application Priority Data
Feb. 4, 2016 (KR) 10-2016-0014379

(51) Int. Cl. H04J 11/00; H04L 1/24; H04L 12/26; H04W 24/06

(52) U.S. Cl. CPC H04J 11/0023; H04W 24/06; H04L 1/244; H04L 43/028

(57) ABSTRACT

Provided is a PIM detection apparatus including: a tone signal input unit configured to apply a tone signal having a first frequency characteristic to a test target apparatus; a sequence signal input unit configured to apply a sequence signal having a second frequency characteristic to the test target apparatus; a PIM detector configured to receive a Passive Intermodulation (PIM) signal from the test target apparatus, and to detect a delay time and a size of the PIM signal based on the sequence signal; and a PIM position determiner configured to determine a PIM occurrence position by using the delay time and the size of the PIM signal.

### CROSS-REFERENCE TO RELATED APPLICATION

This application claims the benefit of priority to Korean Patent Application No. 10-2016-0014379, Feb. 4, 2016 filed on in the Korean Intellectual Property Office, the disclosure of which is incorporated herein in its entirety by reference.

### BACKGROUND OF THE INVENTION

Field of the Invention

The present disclosure relates to an apparatus, a portable apparatus, and a method for detecting Passive Intermodulation (PIM), and more particularly, to a technology of accurately detecting a PIM signal without using a tone signal or a FM modulation signal.

Description of the Related Art

Passive Intermodulation (PIM) is a spurious signal generated by a non-linear characteristic of a passive element, and refers to a phenomenon which deteriorates a communication quality by dropping a signal to noise characteristic in a communication path. That is, if such a PIM occurs, an interference signal is generated in a receiver that receives a frequency generated by the PIM to deteriorate the reception performance.

In the case of a wireless communication system widely used in recent years, PIM may occur due to defect of a device or a connecting line during a step of installing a base station apparatus, or PIM may occur when the device or the connecting line of equipment which had no problem in an initial installation has a non-linear characteristic as it is deteriorated.

In order to eliminate such a PIM signal, firstly, a position where the PIM occurs should be searched, but, conventionally, it is difficult to find a correct occurrence position and cause of the PIM signal.

### SUMMARY OF THE INVENTION

The present disclosure has been made in view of the above problems, and provides an apparatus, a portable apparatus, and a method for detecting PIM capable of accurately detecting an occurrence position of a PIM signal by using a single tone signal and a single sequence signal as a PIM source.

In accordance with an aspect of the present disclosure, a PIM detection apparatus includes: a tone signal input unit configured to apply a tone signal having a first frequency characteristic to a test target apparatus; a sequence signal input unit configured to apply a sequence signal having a second frequency characteristic to the test target apparatus; a PIM detector configured to receive a Passive Intermodulation (PIM) signal from the test target apparatus, and to detect a delay time and a size of the PIM signal based on the sequence signal; and a PIM position determiner configured to determine a PIM occurrence position by using the delay time and the size of the PIM signal. The PIM detection apparatus further includes a display unit configured to display an occurrence position of the PIM signal on a screen. The tone signal input unit includes: an oscillator configured to generate the tone signal having the first frequency characteristic; and a power amplifier configured to amplify the tone signal having the first frequency characteristic into a predefined size. The sequence signal input unit includes: a sequence signal generator configured to output the sequence signal; an oscillator configured to generate a tone signal having the second frequency characteristic; and a mixer configured to multiply the tone signal having the second frequency characteristic by the sequence signal. The sequence signal input unit includes: a sequence signal generator configured to adjust a length of the sequence signal according to a size of the PIM signal and output the adjusted signal; an oscillator configured to generate a tone signal having the second frequency characteristic; and a mixer configured to multiply the tone signal having the second frequency characteristic by the sequence signal. The sequence signal generator increases and outputs the length of the sequence signal when the size of the PIM signal is small, and decreases and outputs the length of the sequence signal when the size of the PIM signal is large. The sequence signal input unit includes a digital-to-analog converter configured to convert a digital sequence signal into an analog signal, which is provided in an output terminal of the sequence signal input unit. The sequence signal input unit includes a power amplifier configured to amplify an output signal of the mixer into a predefined size. The PIM detector includes: an oscillator configured to generate a tone signal having a third frequency characteristic; a mixer configured to multiply a PIM signal received from the test target apparatus by the tone signal having the third frequency characteristic; an analog-to-digital converter configured to convert an analog output signal which is an output of the mixer into a digital signal; and a sequence timing delay time detector configured to detect a delay time of the PIM signal which is a digital signal output from the analog-to-digital converter based on the sequence signal applied by the sequence input unit. The PIM detection apparatus further includes a PIM signal size detector configured to detect a size of the PIM signal to apply to the sequence signal input unit. The PIM signal size detector infers the size of the PIM signal by using an Automatic Gain Control (AGC) value of the analog-to-digital converter, or by using a correlation characteristic of the output signal of the sequence timing delay time detector.

In accordance with another aspect of the present disclosure, a PIM detection apparatus includes: a PIM detector configured to receive a Passive Intermodulation (PIM) signal from a test target apparatus, and to detect a delay time of the PIM signal based on a pre-stored sequence signal; a PIM signal power determiner configured to measure a size of the PIM signal; and a display unit configured to display the size of the PIM signal on a screen. The PIM detector includes: an oscillator configured to generate a tone signal having a third frequency characteristic; a mixer configured to multiply the PIM signal received from the test target apparatus by the tone signal having the third frequency characteristic; and a sequence timing delay time detector configured to detect a delay time of the PIM signal output from the mixer based on pre-stored sequence signal information. The PIM detector includes: a power amplifier configured to amplify the Passive Intermodulation (PIM) signal received from the test target apparatus into a predefined size; a bandpass filter configured to filter the PIM signal amplified by the power amplifier in a preset frequency band; and an analog-to-digital converter configured to convert an analog signal output from the mixer into a digital signal.

In accordance with another aspect of the present disclosure, a PIM detection method includes: applying a tone signal having a first frequency characteristic and a sequence signal having a second frequency characteristic to a test target apparatus; receiving a PIM signal from the test target apparatus, and detecting an occurrence position of the PIM signal; and detecting an intensity of the PIM signal in the occurrence position of the PIM signal by using a portable PIM detection apparatus. Detecting an occurrence position of the PIM signal includes: receiving a PIM signal from the test target apparatus, and detecting a delay time and a size of the PIM signal based on the sequence signal; and determining the occurrence position of the PIM by using the delay time and the size of the PIM signal.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating a configuration of a PIM detection apparatus according to an embodiment of the present disclosure;

FIG. 2 is a graph illustrating a frequency characteristic of a general tone signal and a PIM signal;

FIG. 3 is a graph illustrating a frequency characteristic of a tone input signal, a sequence input signal, and a PIM signal according to an embodiment of the present disclosure;

FIG. 4 is a diagram illustrating a configuration of a portable PIM detection apparatus according to an embodiment of the present disclosure;

FIG. 5 is a flowchart illustrating a PIM occurrence position detection method according to an embodiment of the present disclosure;

FIG. 6 is a diagram illustrating an example of detecting PIM by using the PIM detection apparatus of FIG. 1;

FIG. 7 is a diagram illustrating an example of moving the portable PIM detection apparatus of FIG. 4 to a detected position after the detection of the PIM detection apparatus of FIG. 1 in FIG. 6;

FIG. 8 is a diagram illustrating an example of detecting a PIM occurrence position using the portable PIM detection apparatus of FIG. 4 in a position detected by the PIM detection apparatus of FIG. 1 in FIG. 6; and

FIG. 9 is a diagram illustrating a configuration of a PIM detection apparatus according to another embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

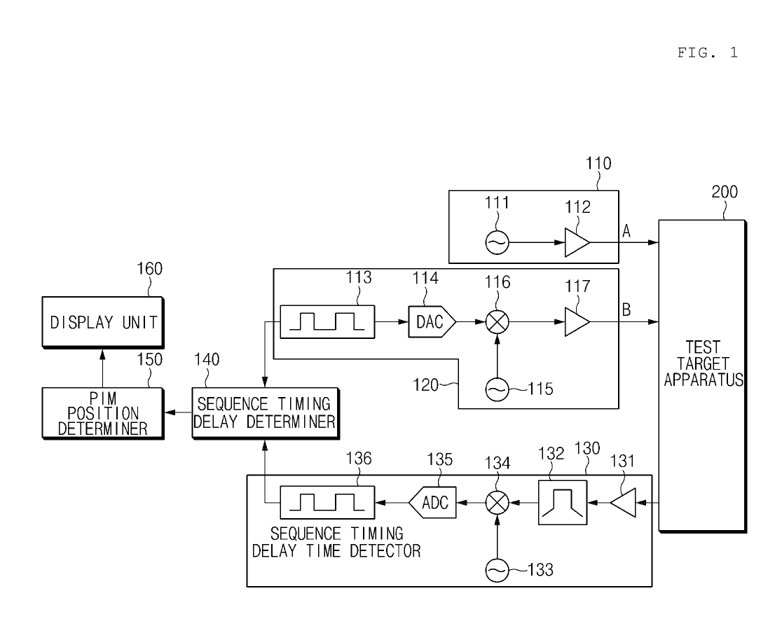

FIG. 1 is a diagram illustrating a configuration of a PIM detection apparatus according to an embodiment of the present disclosure.

The PIM detection apparatus 100 according to an embodiment of the present disclosure may include a tone signal input unit 110 to input a tone signal to a test target apparatus 200, a sequence signal input 120 to input a sequence signal to the test target apparatus 200, a PIM detector 130, a sequence timing delay determiner 140, a PIM position determiner 150, and a display unit 160.

The tone signal input unit 110 may generate a tone signal and transmit to the test target apparatus 200 as an input. To this end, the tone signal input unit 110 may include an oscillator 111 and a power amplifier 112. The oscillator 111 may generate a tone signal having a first frequency characteristic, and the power amplifier 112 may amplify the tone signal generated by the oscillator 111 and send it to the test target apparatus 200.

The sequence signal input unit 120 may generate a sequence signal and transmit to the test target apparatus 200 as an input. To this end, the sequence signal input unit 120 may include a sequence generator 113, a digital-analog converter DAC 114, an oscillator 115, a mixer 116, and a power amplifier 117.

The sequence generator 113 may generate an input sequence. The digital-to-analog converter DAC 114 may convert a sequence signal into an analog signal. In this case, FIG. 1 discloses an example in which a digital sequence signal generated from the sequence generator 113 is directly input to the digital-analog converter 114. However, it may be implemented to pass through a digital filter before inputting the digital sequence signal to the digital-analog converter 114. In addition, a bandwidth of the sequence signal may be restricted by further providing a filter to an output end of the digital-analog converter 114. Further, a sequence frequency may be up-converted by dividing a sequence signal having a second frequency characteristic into two or more signals.

The oscillator 115 may generate a tone signal having a second frequency characteristic.

The mixer 116 may multiply the tone signal having a second frequency characteristic output from the oscillator 115 by the sequence signal output from the sequence generator 113 and output the multiplied value.

The power amplifier 117 may amplify a sequence signal output from the mixer 113 and sent it to the test target apparatus 200.

The PIM detector 130 may receive a PIM signal generated by the test target apparatus 200 and detect the size and position of the PIM signal.

To this end, the PIM detector 130 may include a power amplifier 131, a bandpass filter 132, an oscillator 133, a mixer 134, an analog-to-digital converter ADC 135, and a sequence timing delay time detector 136.

The power amplifier 131 may amplify the PIM signal received from the test target apparatus 200 into a predefined size.

The bandpass filter 132 may filter the PIM signal received from the power amplifier 131 in a preset frequency band. At this time, a center frequency of the bandpass filter 132 may be matched to a center frequency of the PIM signal to be measured. At this time, a frequency of the PIM signal may be down-converted in a homodyne type or in a superheterodyne type, and a configuration of FIG. 1 discloses an embodiment of a homodyne type.

The oscillator 133 may generate a tone signal having a third frequency characteristic.

The mixer 134 may multiply the tone signal having a third frequency characteristic generated from the oscillator 133 by the PIM signal output from the bandpass filter 132 and output the multiplied value.

The analog-to-digital converter ADC 135 may convert an analog signal of the PIM signal output from the mixer 134 into a digital signal.

The sequence timing delay time detector 136 may detect a timing delay time of the digital signal received from the analog-to-digital converter 135. The sequence timing delay time detector 136 may detect a timing delay time of the output sequence signal for the PIM signal output from the test target apparatus 200.

The sequence timing delay determiner 140 may receive an input sequence signal from the sequence generator 113 and receive a delay time detection result of the output sequence signal from the sequence timing delay time detector 136 to determine the degree of sequence timing delay. That is, the sequence timing delay determiner 140 may detect the delay time and the size of the input sequence and the output sequence by using an autocorrelation of the input sequence signal and the output sequence signal (PIM signal) or an autocorrelation of output sequence, so that it is possible to measure the distance of occurrence of the PIM signal.

The PIM position determiner 150 may determine the PIM position by using the output sign PIM position determiner 150 al of the sequence timing delay determiner 140 and transmit to the display unit 160. That is, the PIM position determiner 150 may extract distance information of occurrence of the PIM from a delay time.

The display unit 160 may display PIM position information received from the PIM position determiner 150 on a screen.

Thus, the PIM detection apparatus according to the present disclosure may apply a tone signal having an arbitrary first frequency characteristic, and a sequence signal obtained by multiplying a digital sequence signal by a tone signal having a second frequency characteristic to the test target apparatus 200, and detect a timing delay time for the PIM signal output from the test target apparatus 200 so that it is possible to determine the position of occurrence of the PIM signal according to the delay time.

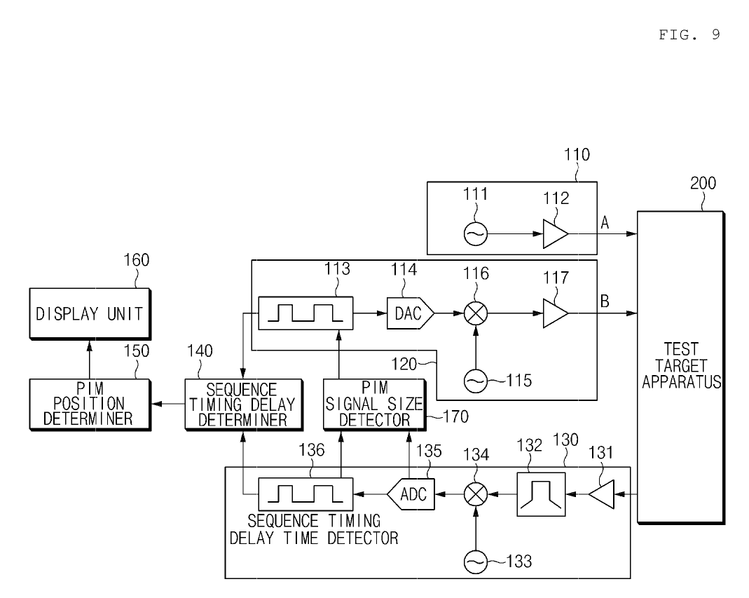

Meanwhile, when generating an input sequence signal, the sequence generator 113 may adjust the length of the input sequence signal based on the size of the PIM signal. FIG. 9 is a diagram illustrating a configuration of a PIM detection apparatus according to another embodiment of the present disclosure, and discloses an example of adding a PIM signal size detector 170 to the configuration of FIG. 1.

Referring to FIG. 9, the sequence generator 113 may receive PIM signal information from the PIM signal size detector 170 and adjust the length of the sequence signal based on the size of the PIM signal. That is, the sequence generator 113 may enhance the reception sensitivity by increasing the length of the sequence signal when the size of the PIM signal is small, and may enhance a PIM signal detection rate by shortening the length of the sequence signal when the size of the PIM signal is large.

At this time, in order to detect the PIM size signal, the PIM signal size detector 170 may infer the size of the PIM signal by using an Automatic Gain Control (AGC) value of the analog-to-digital converter 135 or by using a correlation characteristic of the output signal of the sequence timing delay time detector 136.

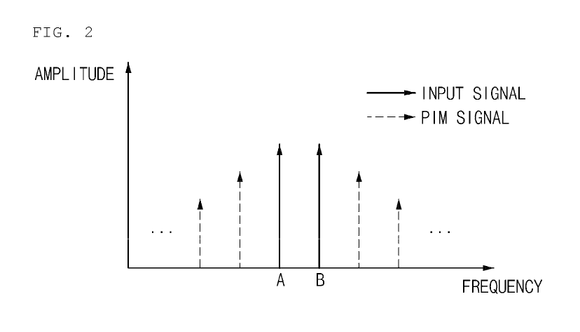

FIG. 2 is a graph illustrating a frequency characteristic of a general tone signal and a PIM signal. Referring to FIG. 2, when two tone signals having different frequency characteristic (A, B) are input to the test target apparatus 200, it shows a frequency characteristic of the PIM signal.

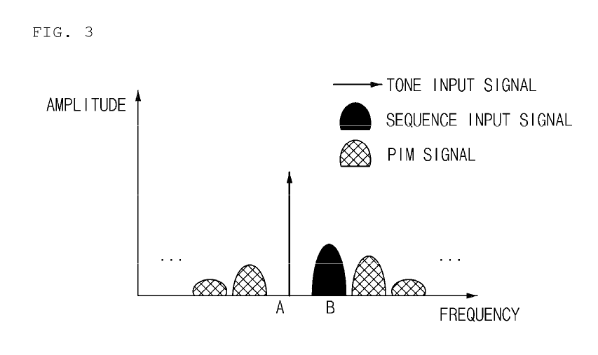

FIG. 3 is a graph illustrating a frequency characteristic of a tone input signal, a sequence input signal, and a PIM signal according to an embodiment of the present disclosure, and shows a frequency characteristic of a PIM signal when a tone signal having a first frequency characteristic and a sequence signal having a second frequency characteristic are input to the test target apparatus 200. In general, if A, B two signals are input in an ideal power line, other signal excluding A, B signals does not appear. However, if a problem occurs due to deterioration of a power line, an intermodulation between A, B two signals occur to generate a PIM signal, which produces adverse effect in a system. FIG. 2 shows an appearance of the PIM signal when two tone signals are transmitted to a non-ideal power line, and FIG. 3 shows an appearance of the PIM signal when an input signal proposed in the present disclosure is transmitted to the non-ideal power line.

Thus, whereas the PIM signal is detected by using conventional two tone signals, the present disclosure detects a PIM signal by using a single tone signal and a single sequence signal.

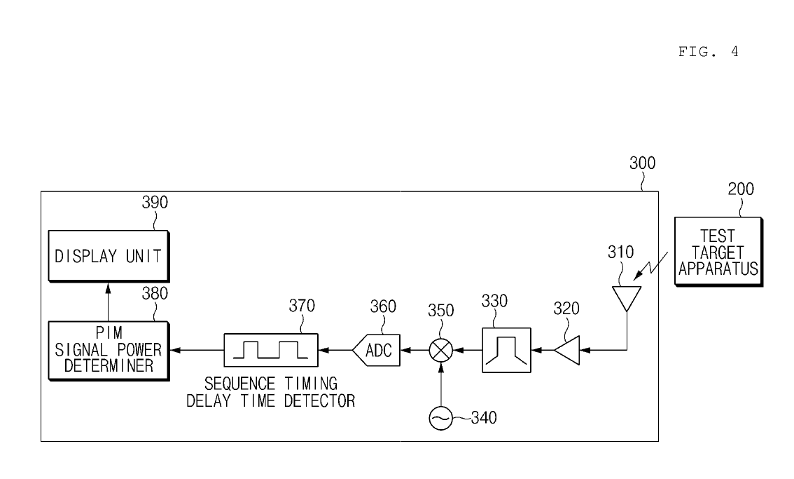

That is, a conventional method of using two tone signals is basically based on a Frequency Modulated Continuous Wave (FMCW) Rader technology, which has to rely on the amplitude and time delay of two signal generator signals to perform detection. However, such a conventional method is difficult to obtain a coding gain so that it is difficult to detect a PIM signal when the size of the PIM signal is small. In particular, in the case of the conventional method, even if the position of the PIM occurrence is known, the PIM signal cannot be detected when the PIM signal is small. When detecting a PIM signal by using the PIM detection apparatus of FIG. 1, the position where the PIM signal is generated can be roughly searched. That is, if the structure of the communication equipment installed in a building is complex, when the PIM position is searched by using the PIM detection apparatus of FIG. 1, the accuracy may be low. Thus, an example of finding the portion where the PIM signal has a large power by using an interior of the building by using the portable PIM detection apparatus of FIG. 4, and more accurately detecting the position of the PIM signal occurrence, after finding the position of the PIM occurrence by using the PIM detection apparatus of FIG. 1 is illustrated.

FIG. 4 is a diagram illustrating a configuration of a portable PIM detection apparatus according to an embodiment of the present disclosure.

The portable PIM detection apparatus 300 according to an embodiment of the present disclosure may be carried by a user, and may include an antenna 310, a power amplifier 320, a bandpass filter 330, an oscillator 340, a mixer 350, an analog-to-digital converter ADC 360, a sequence timing delay time detector 370, a PIM signal power determiner 380, and a display unit 390.

The antenna 310 may receive a PIM signal wirelessly from the test target apparatus 200. At this time, the antenna 310 may be implemented as a directional antenna.

The power amplifier 320 may amplify the PIM signal received through the antenna 310 into a predefined size.

The bandpass filter 330 may filter the amplified PIM signal in a predefined band.

The oscillator 340 may generate a tone signal having a third frequency characteristic.

The mixer 350 may multiply the tone signal having a third frequency characteristic by the PIM signal passed through the bandpass filter 330.

The analog-to-digital converter ADC 360 may convert an analog signal output from the mixer 350 into a digital signal.

The sequence timing delay time detector 370 may detect a delay time of a previously known sequence and the received PIM signal (sequence signal) from the converted digital signal to transmit to the PIM signal power determiner 380.

The PIM signal power determiner 380 may detect the size of a PIM signal by using a correlation with the received PIM signal (sequence signal) using the previously known sequence information or by using an autocorrelation. At this time, the detection accuracy may be improved by adjusting the length of the sequence signal which takes correlation according to the magnitude of the PIM signal. That is, the sequence length is decreased when the detection distance is short or the size of the PIM signal is large, and the sequence length is increased when the detection distance is long or the size of the PIM signal is small.

The display unit 390 may display a power of the PIM signal detected by the PIM signal power determiner 380 on a screen.

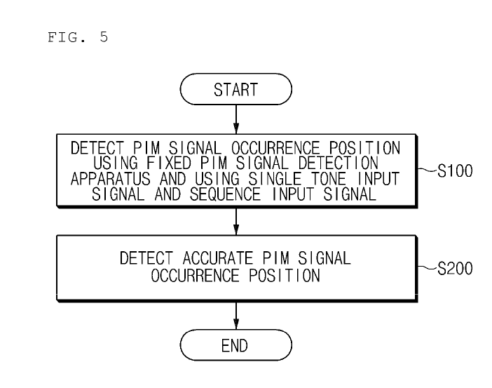

Hereinafter, a PIM occurrence position detection method is illustrated with reference to FIG. 5.

Referring to FIG. 5, a single tone input signal and a sequence input signal may be applied to the test target apparatus 200 using a fixed PIM signal detection apparatus of FIG. 1, and the PIM signal occurrence position applied from the test target apparatus 200 may be detected (S100).

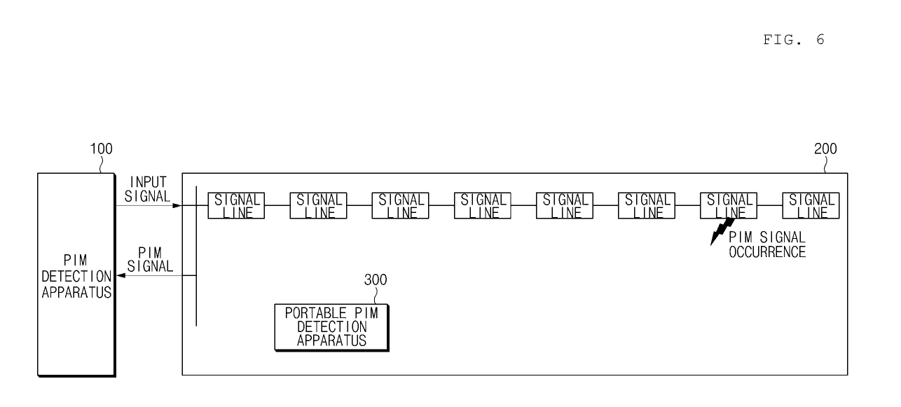

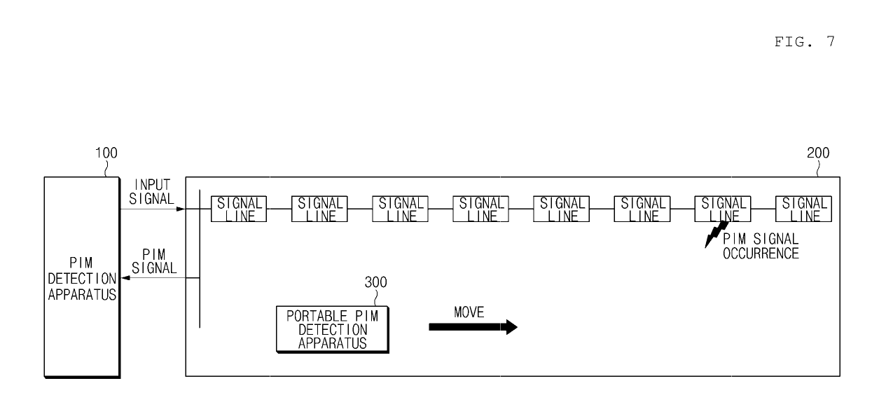

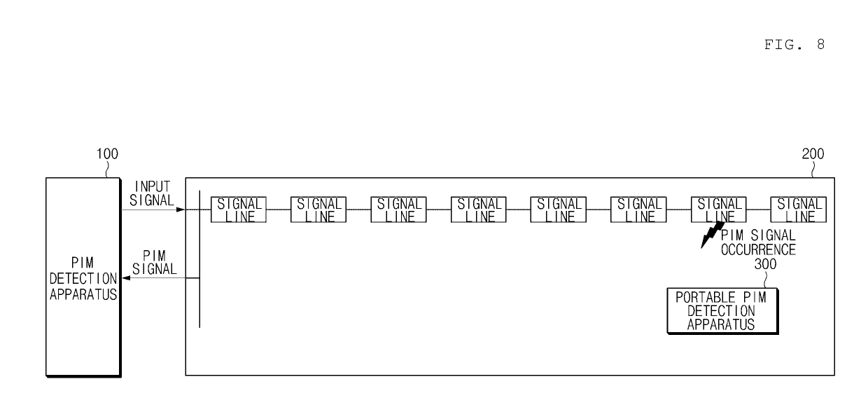

FIG. 6 is a diagram illustrating an example of detecting PIM by using the PIM detection apparatus of FIG. 1, FIG. 7 is a diagram illustrating an example of moving the portable PIM detection apparatus of FIG. 4 to a detected position after the detection of the PIM detection apparatus of FIG. 1 in FIG. 6, and FIG. 8 is a diagram illustrating an example of detecting a PIM occurrence position using the portable PIM detection apparatus of FIG. 4 in a position detected by the PIM detection apparatus of FIG. 1 in FIG. 6.

Referring to FIG. 6, an external PIM detection apparatus 100 may roughly detect the PIM signal occurrence position with respect to the test target apparatus 200. As shown in FIG. 7, the portable PIM detection apparatus 300 may be carried to the PIM signal occurrence position detected by the fixed PIM detection apparatus 100 of FIG. 1 from the inside of the building, and, as shown in FIG. 7, the intensity of a PIM signal of a corresponding position may be measured by using the portable PIM detection apparatus 300 so that it is possible to accurately detect the PIM signal occurrence position (S200).

Thus, after detecting the PIM occurrence position by using the fixed PIM detection apparatus 100, the intensity of a PIM signal of a corresponding position may be measured by using the portable PIM detection apparatus 300 so as to determine whether the PIM occurrence position is correct so that it is possible to clearly detect the PIM occurrence position.

The present technology can accurately detect an occurrence position of PIM by using a single tone signal and a single sequence signal as a PIM source.

In addition, the present technology can measure the intensity of the PIM signal of a corresponding position by using a portable PIM detection apparatus even if an occurrence position of PIM is detected by using a fixed PIM detection apparatus, so that it is possible to minimize an error of detection of occurrence position of PIM

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A PIM detection apparatus comprising:
a tone signal input unit configured to apply a tone signal having a first frequency characteristic to a test target apparatus;
a sequence signal input unit configured to apply a sequence signal having a second frequency characteristic to the test target apparatus;
a PIM detector configured to receive a Passive Intermodulation (PIM) signal from the test target apparatus, and to detect a delay time and a size of the PIM signal based on the sequence signal; and
a PIM position determiner configured to determine a PIM occurrence position by using the delay time and the size of the PIM signal.

2. The PIM detection apparatus of claim 1, further comprising a display unit configured to display an occurrence position of the PIM signal on a screen.

3. The PIM detection apparatus of claim 1, wherein the tone signal input unit comprises:
an oscillator configured to generate the tone signal having the first frequency characteristic; and
a power amplifier configured to amplify the tone signal having the first frequency characteristic into a predefined size.

4. The PIM detection apparatus of claim 1, wherein the sequence signal input unit comprises:
a sequence signal generator configured to output the sequence signal;
an oscillator configured to generate a tone signal having the second frequency characteristic; and
a mixer configured to multiply the tone signal having the second frequency characteristic by the sequence signal.

5. The PIM detection apparatus of claim 1, wherein the sequence signal input unit comprises:
a sequence signal generator configured to adjust a length of the sequence signal according to a size of the PIM signal and output the adjusted signal;
an oscillator configured to generate a tone signal having the second frequency characteristic; and
a mixer configured to multiply the tone signal having the second frequency characteristic by the sequence signal.

6. The PIM detection apparatus of claim 5, wherein the sequence signal generator increases and outputs the length of the sequence signal when the size of the PIM signal is small, and decreases and outputs the length of the sequence signal when the size of the PIM signal is large.

7. The PIM detection apparatus of claim 4, wherein the sequence signal input unit comprises a digital-to-analog converter configured to convert a digital sequence signal into an analog signal, which is provided in an output terminal of the sequence signal input unit.

8. The PIM detection apparatus of claim 7, wherein the sequence signal input unit comprises a power amplifier configured to amplify an output signal of the mixer into a predefined size.

9. The PIM detection apparatus of claim 1, wherein the PIM detector comprises:
an oscillator configured to generate a tone signal having a third frequency characteristic;
a mixer configured to multiply a PIM signal received from the test target apparatus by the tone signal having the third frequency characteristic;
an analog-to-digital converter configured to convert an analog output signal which is an output of the mixer into a digital signal; and
a sequence timing delay time detector configured to detect a delay time of the PIM signal which is a digital signal output from the analog-to-digital converter based on the sequence signal applied by the sequence input unit.

10. The PIM detection apparatus of claim 9, further comprising a PIM signal size detector configured to detect a size of the PIM signal to apply to the sequence signal input unit.

11. The PIM detection apparatus of claim 10, wherein the PIM signal size detector infers the size of the PIM signal by using an Automatic Gain Control (AGC) value of the analog-to-digital converter, or by using a correlation characteristic of the output signal of the sequence timing delay time detector.

12. A PIM detection apparatus comprising:
a PIM detector configured to receive a Passive Intermodulation (PIM) signal from a test target apparatus, and to detect a delay time of the PIM signal based on a pre-stored sequence signal;
a PIM signal power determiner configured to measure a size of the PIM signal; and
a display unit configured to display the size of the PIM signal on a screen.

13. The PIM detection apparatus of claim 12, wherein the PIM detector comprises:
an oscillator configured to generate a tone signal having a third frequency characteristic;
a mixer configured to multiply the PIM signal received from the test target apparatus by the tone signal having the third frequency characteristic; and
a sequence timing delay time detector configured to detect a delay time of the PIM signal output from the mixer based on pre-stored sequence signal information.

14. The PIM detection apparatus of claim 13, wherein the PIM detector comprises:
a power amplifier configured to amplify the Passive Intermodulation (PIM) signal received from the test target apparatus into a predefined size;
a bandpass filter configured to filter the PIM signal amplified by the power amplifier in a preset frequency band; and
an analog-to-digital converter configured to convert an analog signal output from the mixer into a digital signal.

15. A PIM detection method comprising:
applying a tone signal having a first frequency characteristic and a sequence signal having a second frequency characteristic to a test target apparatus;
receiving a PIM signal from the test target apparatus, and detecting an occurrence position of the PIM signal; and
detecting an intensity of the PIM signal in the occurrence position of the PIM signal by using a portable PIM detection apparatus.

16. The PIM detection method of claim 15, wherein detecting an occurrence position of the PIM signal comprises:
receiving a PIM signal from the test target apparatus, and detecting a delay time and a size of the PIM signal based on the sequence signal; and
determining the occurrence position of the PIM by using the delay time and the size of the PIM signal.
